(19) United States
(12) Patent Application Publication
(10) Pub. No.: US 2019/0163399 A1
(43) Pub. Date: May 30, 2019

(54) INFORMATION PROCESSING SYSTEM AND INFORMATION PROCESSING METHOD

(71) Applicant: Hitachi, Ltd., Tokyo (JP)

(72) Inventors: Takashi OKADA, Tokyo (JP); Go UEHARA, Tokyo (JP); Yusaku KIYOTA, Tokyo (JP)

(21) Appl. No.: 16/122,909

(22) Filed: Sep. 6, 2018

(30) Foreign Application Priority Data
Nov. 30, 2017 (JP) 2017-231221

(51) Int. Cl. G06F 3/06; G06F 11/07

(52) U.S. Cl. CPC G06F 3/0659; G06F 11/0727; G06F 3/0673; G06F 11/0772; G06F 3/0604; G06F 11/0751

(57) ABSTRACT

An information processing system and method effectively prevents data loss and the like caused by the duplicate execution of commands. A controller writes a command for a device to a corresponding command queue. The device fetches the command from the corresponding command queue. The command includes a field for storing fetch information which indicates whether the command has been fetched. The device refers to a value of the fetch information of the fetched command. If the value of the fetch information is a first value indicating that the command has not been fetched, the device executes the command after updating the value of the fetch information of the command which is stored in the corresponding command queue to a second value indicating that the command has been fetched. If the value of the fetch information is the second value, the device executes predetermined error processing instead of executing the command.

### CROSS-REFERENCE TO PRIOR APPLICATION

This application relates to and claims the benefit of priority from Japanese Patent Application number 2017-231221, filed on Nov. 30, 2017 the entire disclosure of which is incorporated herein by reference.

### BACKGROUND

The present invention generally relates to an information processing system and information processing method, and, for instance, can be suitably applied to a storage apparatus.

Typically, a device which processes commands determines whether the format of a supplied command is as prescribed, at the time of execution, and if the format is not as prescribed, the device cancels execution of the command and executes predetermined error processing such as sending an error notification to the device driver (hereinafter simply called the driver) which issued the command.

Further, a system, which has a configuration in which a driver writes commands to a command queue which is defined in a memory, and a device fetches these commands, is considered.

In a system of this kind, due to a problem with the driver or device or memory failure, and the like, a pointer indicating the position of the command in the command queue to be fetched next does not point to a correct command, and sometimes the device re-fetches a command in the command queue which has already been executed.

In such a case, the format of the command that is fetched at the time is as prescribed, and therefore it is not possible to discriminate the command in the device as being invalid, and the command is re-executed as is.

However, if this re-executed command is a write command that is issued from a storage controller in the storage apparatus to a memory device, for example, this results in data that has already been written to the memory device being newly overwritten with data.

Moreover, here, if the same area is overwritten with different data based on a different write command during the time between a state where the command was first executed until the command is re-executed, this data is rewritten with the original data due to the erroneously executed write command, and consequently, there is a risk of the correct data being lost.

As a method of suppressing this duplicate execution of commands, PTL 1, for example, discloses a method of appending rank order information to a request when the sender of requests issues a request, and determining whether the received request has been processed based on the rank order information appended to each request.

[PTL 1] Japanese Laid-Open Patent Application Publication No. 2013/191187.

### SUMMARY

However, according to the method disclosed in PTL 1, because it is necessary to manage the rank order information required to determine whether a request has been processed, in the device sending the request, there has been a problem in that, when the device is replaced, the new replacement device is unable to ascertain which requests have been processed and which request to start with when processing requests.

Therefore, to effectively and reliably prevent data loss caused by the duplicate execution of requests, a mechanism is required that, following device replacement, will enable a new device to ascertain easily which command to start with when processing commands.

The present invention was devised in view of the foregoing points and an object of this invention is to propose a highly reliable information processing system and information processing method capable of effectively preventing data loss and the like caused by the duplicate execution of commands.

In order to solve this problem, according to the present invention, an information processing system comprises one or more devices which execute predetermined processing, a controller which controls the devices, and a memory which is provided in the controller and in which command queues for each of the devices are defined. The controller writes a command for a device to a corresponding command queue which is the command queue corresponding to the device. The device fetches the command from the corresponding command queue. The command includes a field for storing fetch information which indicates whether the command has been fetched. The device refers to the value of the fetch information of the fetched command. If the value of the fetch information is a first value indicating that the command has not been fetched, the device executes the command after updating the value of the fetch information of the command which is stored in the corresponding command queue to a second value indicating that the command has been fetched. If the value of the fetch information is the second value, the device executes predetermined error processing instead of executing the command.

The present invention is an information processing method which is executed in an information processing system which comprises one or more devices which execute predetermined processing, a controller which controls the devices, and a memory which is provided in the controller and in which command queues for each of the devices are defined. The information processing method comprises a first step in which a device among the devices refers to a value of fetch information of a command fetched by the device. The controller is configured to write the command for the device to a corresponding command queue which is the command queue corresponding to the device. The device is configured to fetch the command from the corresponding command queue. The command includes a field for storing the fetch information which indicates whether the command has been fetched. The information processing method further comprises a second step in which, if the value of the fetch information is a first value indicating that the command has not been fetched, the device executes the command after updating the value of the fetch information of the command which is stored in the corresponding command queue to a second value indicating that the command has been fetched, and if the value of the fetch information is the second value, the device executes predetermined error processing instead of executing the command.

According to the information processing system and information processing method, because the fetch information that is required to ascertain whether a command has been fetched is collectively managed in the controller, even if the device has been replaced, the new post-replacement device is able to recognize easily and reliably which command among the commands stored in the command queue to start fetching and executing.

According to the present invention, it is possible to realize a highly reliable information processing system and information processing method capable of effectively preventing data loss and the like caused by the duplicate execution of commands.

### BRIEF DESCRIPTION OF DRAWINGS

FIG. 1 is a block diagram showing an overall configuration of a storage apparatus according to the first embodiment.

FIG. 2 is a block diagram showing the flow of I/O processing in the storage apparatus according to the first embodiment.

FIG. 3 is a conceptual drawing serving to explain a submission queue and commands.

FIG. 4 is a conceptual drawing showing a command format according to this embodiment.

FIG. 5A is a ladder chart showing the flow of processing when an affirmative result is obtained in a fetched flag determination in the storage apparatus according to the first embodiment.

FIG. 5B is a ladder chart showing the flow of processing when a negative result is obtained in the fetched flag determination in the storage apparatus according to the first embodiment.

FIG. 6 is a flowchart showing process steps of driver command processing.

FIG. 7 is a flowchart showing process steps of flash controller command processing.

FIG. 8 is a block diagram showing an overall configuration of a storage apparatus according to a second embodiment.

FIG. 9 is a block diagram showing the flow of write processing in the storage apparatus according to the second embodiment.

### DESCRIPTION OF EMBODIMENTS

An embodiment of the present invention will now be explained in detail with reference to the appended drawings.

### (1) First Embodiment

(1-1) Configuration of the Storage Apparatus According to this Embodiment.

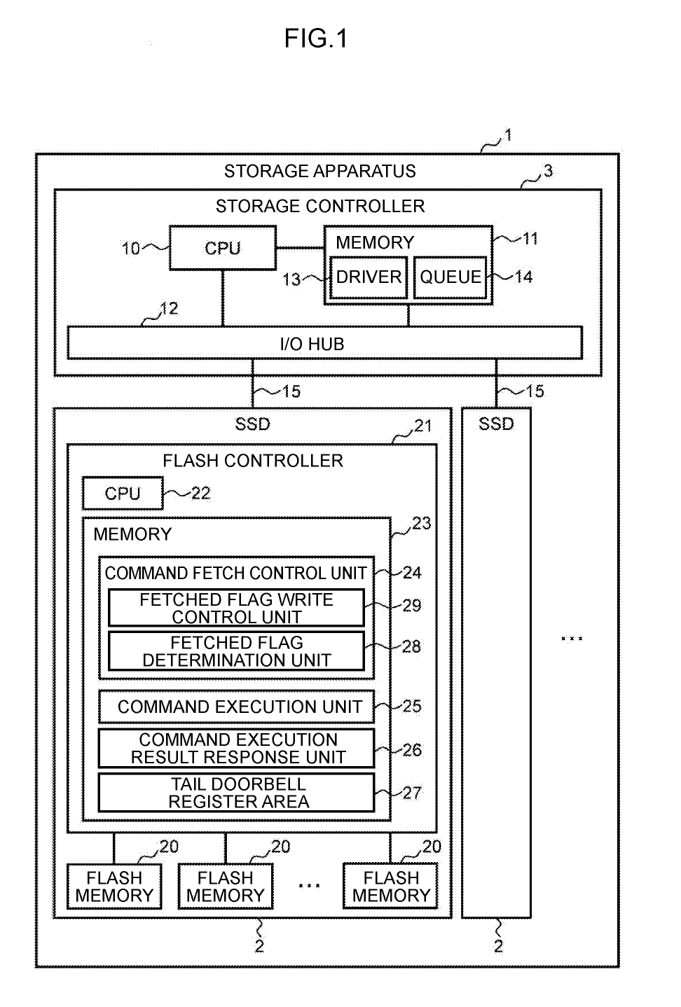

In FIG. 1, 1 denotes the whole storage apparatus according to this embodiment. This storage apparatus 1 is configured by comprising one or more SSD (Solid State Device) 2 and a storage controller 3 which controls the reading and writing of data from/to the SSD 2.

The storage controller 3 is configured by comprising a CPU (Central Processing Unit) 10, a memory 11, and an I/O (Input/Output) hub 12. The CPU 10 is a processor which is tasked with controlling the overall operation of the storage apparatus 1, and the memory 11 is a semiconductor memory that is used to hold various programs.

The memory 11 stores an SSD driver (hereinafter simply called the driver) 13. The driver 13 is a program enabling the storage controller 3 to control the SSD 2. As a result of the CPU 10 executing the driver 13, various control of the SSD 2 is performed by the storage controller 3. However, in the ensuing explanation, the processing entities of the various processing that the CPU 10 executes based on the driver 13 will be explained as the driver 13.

Moreover, one or more submission queues 14 are defined, for each SSD 2, in the memory 11. The submission queues 14 are command queues enabling the driver 13 to write commands to the corresponding SSD 2. The writing of commands to the submission queues 14 is performed such that the commands are written in order starting from the head and when the submission queue is full, writing returns to the head and commands are overwritten.

The I/O hub 12 is a distributor that switches the connection between the CPU 10 and memory 11, and the SSD 2, under the control of the CPU 10. The I/O hub 12 is connected to each SSD 2 via a PCIe (Peripheral Component Interconnect express) bus 15.

The SSD 2 are each configured by comprising one or more flash memories 20 having a plurality of built-in NAND-type flash chips, and a flash controller 21 which reads and write data from/to the corresponding flash memory 20 according to commands supplied from the storage controller 3, for example.

The flash controller 21 comprises a CPU 22 which is a processor tasked with controlling the overall operation of the SSD 2, and a memory 23 that is mainly used to hold programs. Furthermore, the memory 23 stores a command fetch control unit 24, a command execution unit 25, and a command execution result response unit 26, as programs. Moreover, tail doorbell register areas 27 are secured in the memory 11.

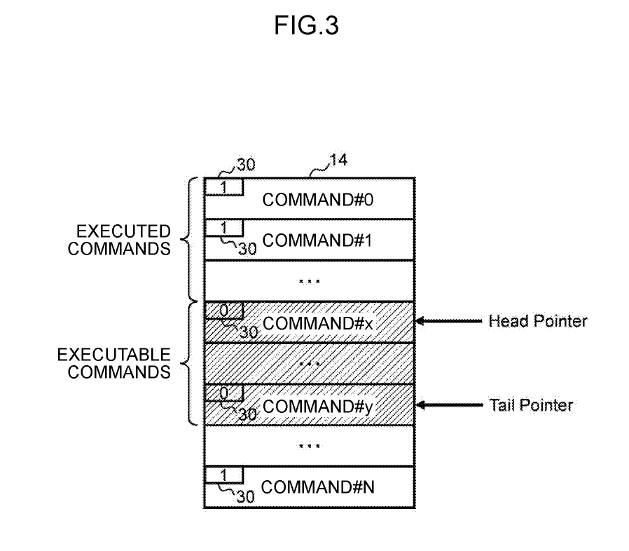

The tail doorbell register areas 27 are register areas enabling the driver 13 of the storage controller 3 to write tail pointers (FIG. 3) indicating the position of the command written last to the submission queue 14 when a command is written to the corresponding submission queue.

Moreover, the command fetch control unit 24 is a program that comprises a function which reads the command from the corresponding submission queue 14 defined on the memory 11 in the storage controller 3 via the PCIe bus 15 by using a tail pointer stored in the tail doorbell register area 27 according to a notification (hereinafter called the command write notification) supplied from the driver 13 when the driver 13 has written the command to the corresponding submission queue 14.

The command execution unit 25 is a program which comprises a function for executing the command which has been read by the command fetch control unit 24 from the corresponding submission queue 14. Moreover, the command execution result response unit 26 is a program which comprises a function for notifying the storage controller 3 of the result of executing the command executed by the command execution unit 25.

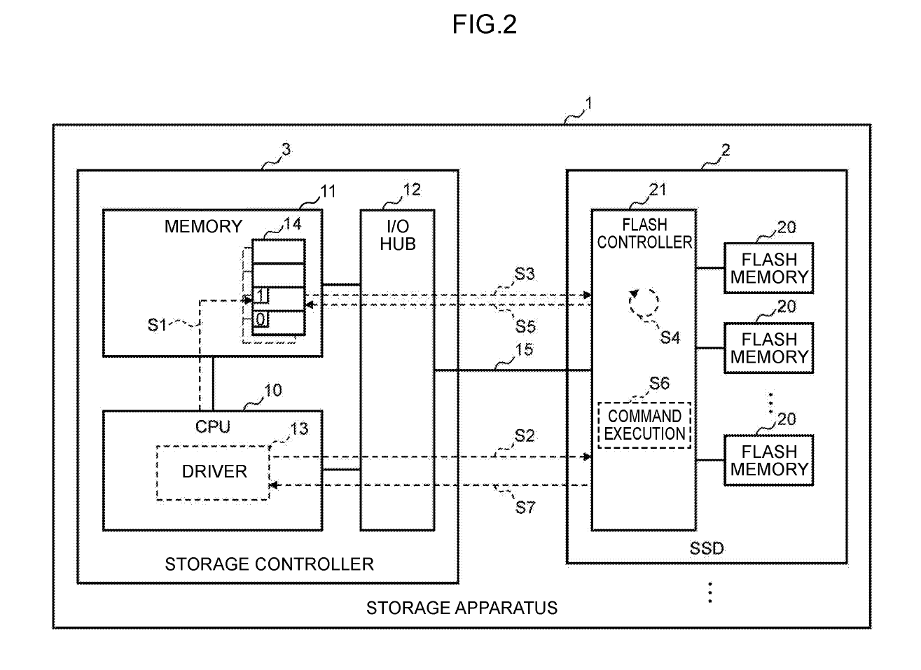

In the storage apparatus 1 which comprises the foregoing configuration, when an I/O request such as a read request or write request is supplied from a host device (not shown), as shown in FIG. 2, the driver 13 of the storage controller 3 generates commands in a predetermined format for each corresponding SSD 2 in response to the I/O request, and writes the generated commands to the submission queue 14 corresponding to the SSD 2 (S1).

Furthermore, the driver 13 then sends the command write notification to the corresponding SSD 2 (S2). Note that the command write notification includes the tail pointer which indicates the position, at the time, of the command which was written last to the corresponding submission queue 14 (a position starting from the head of the submission queue 14), and this tail pointer is stored in the tail doorbell register area 27 (FIG. 1) by the command fetch control unit 24.

Meanwhile, the command fetch control unit 24 of the flash controller 21 of the SSD 2 stores the position of the oldest non-executed command among the commands written to the corresponding submission queue 14 as the head pointer (FIG. 3).

Moreover, when this command write notification is supplied, the command fetch control unit 24 accesses the corresponding submission queue 14 defined on the memory 11 in the storage controller 3 via the PCIe bus 15, fetches, from among the commands stored in the submission queue 14, the number of commands that can be processed at the time from among the commands from the head pointer to the tail pointer stored in the tail doorbell register area 27, in order starting with the oldest command written to the submission queue 14, and transfers the fetched commands to the command execution unit 25 (FIG. 1) (S3).

Moreover, the command execution unit 25 executes each of the commands transferred from the command fetch control unit 24 in order (S6), and sequentially transfers the execution results to the command execution result response unit 26 (FIG. 1). Thus, the command execution result response unit 26 which has transferred the command execution results writes the requested read data to the memory 11 of the storage controller 3 if the command is a read command, and then sends the command execution result to the driver 13 as a command execution result response (S7).

Thereafter, if the I/O request from the host device is a write request, for example, the storage controller 3 sends notification that the write processing is complete (write completion notification) to the host device. Moreover, if the I/O request from the host device is a read request, the storage controller 3 sends the read data stored in the memory 11 and also notification that the read processing is complete (read completion notification) to the host device. As a result of the foregoing, serial processing corresponding to I/O requests from the host device are completed.

### (1-2) Fetched Determination Function

Further, in the storage apparatus 1 which comprises such a configuration, there is a risk, due to lag of the command fetch control unit 24 (FIG. 1) or failure and the like of the memory 23 of the storage controller 3, that the same commands, which have been written to the corresponding submission queue 14, will be fetched multiple times by the command fetch control unit 24 and executed in the SSD 2. Further, if commands are thus executed in duplicate, there is a risk of data loss as mentioned hereinabove.

Therefore, according to this embodiment, as shown in FIG. 3, a command which the driver 13 writes to the submission queue 14 comprises a field (hereinafter called a fetched flag field) 30 for storing a flag for managing whether the command has been fetched (hereinafter called a fetched flag).

This fetched flag is first initialized to ‘0’ by the driver. Further, the command fetch control unit 24 (FIG. 1) of the flash controller 21 of the SSD 2 updates the fetched flag of the command stored in the corresponding submission queue 14 to ‘1’ each time the command is fetched from the submission queue, as shown in step S5 in FIG. 2.

Further, as shown in step S4 in FIG. 2, the command fetch control unit 24 determines the value of the fetched flag of the fetched command each time the command is fetched from the corresponding submission queue 14, and if the value is ‘0’, transfers the command to the command execution unit 25 to have the command executed, but if the value is ‘1’, the command fetch control unit 24 does not transfer the command to the command execution unit 25 and notifies the storage controller 3 of an error.

As means for realizing such a function (hereinafter called the fetched determination function), as shown in FIG. 1, the command fetch control unit 24 comprises, among its functions, a fetched flag determination unit 28 and a fetched flag write control unit 29.

The fetched flag determination unit 28 is a function module which enables the command fetch control unit 24 to determine whether the value of the fetched flag of a fetched command is ‘0’ or ‘1.’

Further, the fetched flag write control unit 29 is a function module which, for a command that has been determined by the fetched flag determination unit 28 to have a fetched flag value of ‘0,’ updates the fetched flag of the command in the corresponding submission queue 14 to ‘1.’

Further, the command fetch control unit 24 determines, using the fetched flag determination unit 28 and fetched flag write control unit 29, whether the command from the corresponding submission queue 14 has already been executed when the command is fetched from the corresponding submission queue 14, and changes the fetched flag value of the command in the corresponding submission queue 14 to ‘1.’

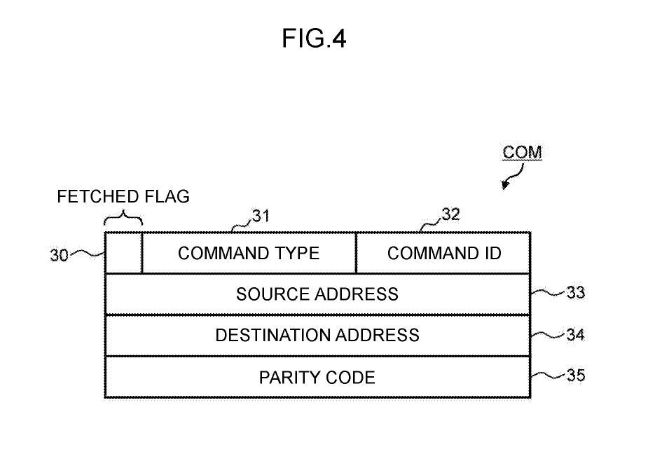

Note that a specific configuration example of the command according to this embodiment is shown in FIG. 4. As shown in FIG. 4, in the case of this embodiment, a command COM is configured by comprising a fetched flag field 30, a command type field 31, a command ID field 32, a source address field 33, a destination address field 34, and a parity code field 35.

The fetched flag field 30 is a one-bit field in which the fetched flag is stored as described hereinabove. Moreover, the command type field 31 stores the type of the command COM such as a ‘read,’ ‘write,’ or ‘copy’ command, the command ID field 32 stores an individual ID that is assigned to the command COM, and the parity code field 35 stores a parity code for the command COM.

Moreover, the source address field 33 stores an address on the SSD 2 or memory 11 where data to be processed is stored, and the destination address field 34 stores an address on the SSD 2 or memory 11 where the processing result of this data is to be stored. Therefore, if the command type is ‘copy,’ for example, the address of the copy source area where the copy target data in the SSD 2 is stored is stored in the source address field 33, and the address of the copy destination area of the data in the SSD 2 is stored in the destination address field 34.

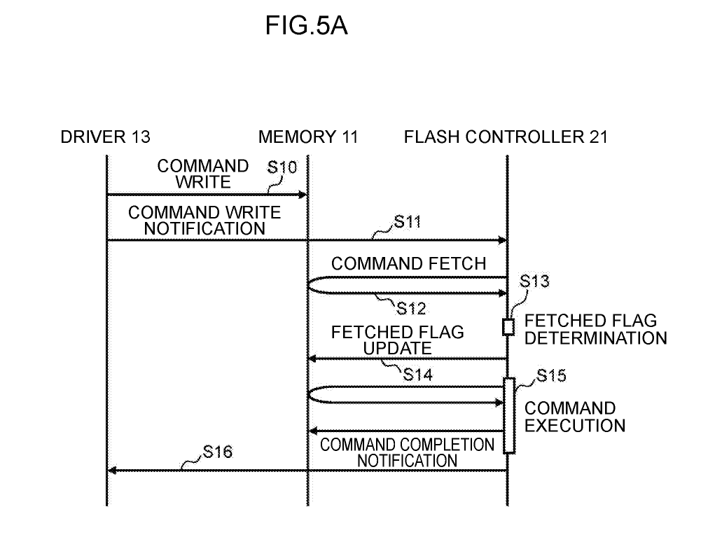

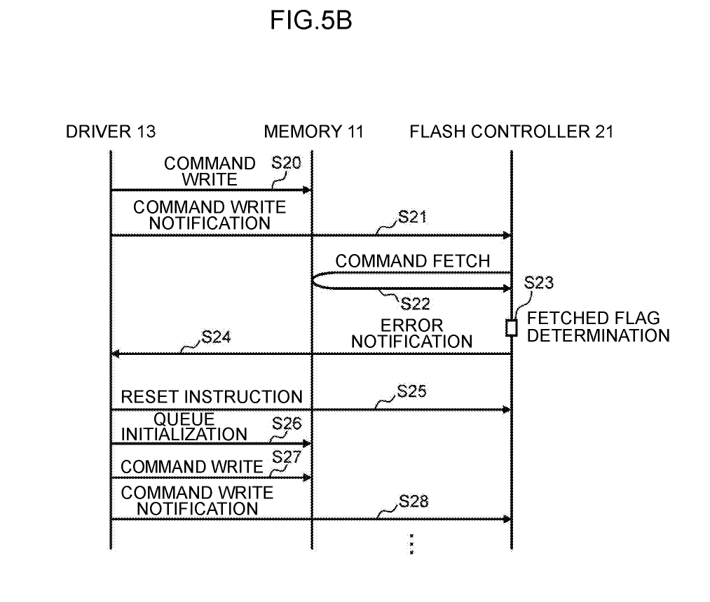

FIG. 5A shows the flow of serial processing in a case where it is determined in the determination of step S4 of FIG. 2 that the value of the fetched flag is ‘0.’ An explanation of steps S10 to S11 in this case, which all have the same processing content as steps S1 to S7 in FIG. 2, is omitted.

Meanwhile, FIG. 5B shows the flow of serial processing in a case where it is determined in the determination of step S4 of FIG. 2 that the value of the fetched flag is ‘1.’ An explanation of steps S20 to S23 in this case, which have the same processing content as steps S1 to S4 in FIG. 2, is omitted.

If, in the determination of step S23, the fetched flag determination unit 28 (FIG. 1) of the flash controller 21 of the SSD 2 determines that the value of the fetched flag of at least one of the commands fetched from the corresponding submission queue 14 by the command fetch control unit 24 (FIG. 1) is ‘1’, the fetched flag determination unit 28 does not transfer the command to the command execution unit 25, and sends an error message to the driver 13 (FIG. 1) of the storage controller 3 (FIG. 1) (S24).

Meanwhile, upon receiving this error message, the driver 13 of the storage controller 3 (FIG. 1) discards all the information held by the flash controller 21 by supplying a reset instruction to the flash controller 21 of the SSD 2 (S25). However, the user data stored in the SSD 2 is not lost.

Moreover, by initializing the submission queue 14 associated with the SSD 2 defined in the memory 11, the driver 13 deletes all the commands which have been written to the submission queue 14 at the time (S26).

Further, the driver 13 rewrites all the non-executed commands stored in the submission queue 14 which have not been initialized by the time of the initialization in step S26, to the submission queue 14 (S27), and subsequently sends the corresponding command write notification to the flash controller 21 of the SSD 2 (S28). As a result, the processing of step S22 and subsequent steps is re-executed in the SSD 2.

### (1-3) Processing of the Driver and Flash Controller Relating to the Fetched Determination Function

The processing content of serial processing that is executed by the driver 13 and flash controller 21 and relating to the foregoing fetched determination function will be explained next.

### (1-3-1) Driver Command Processing

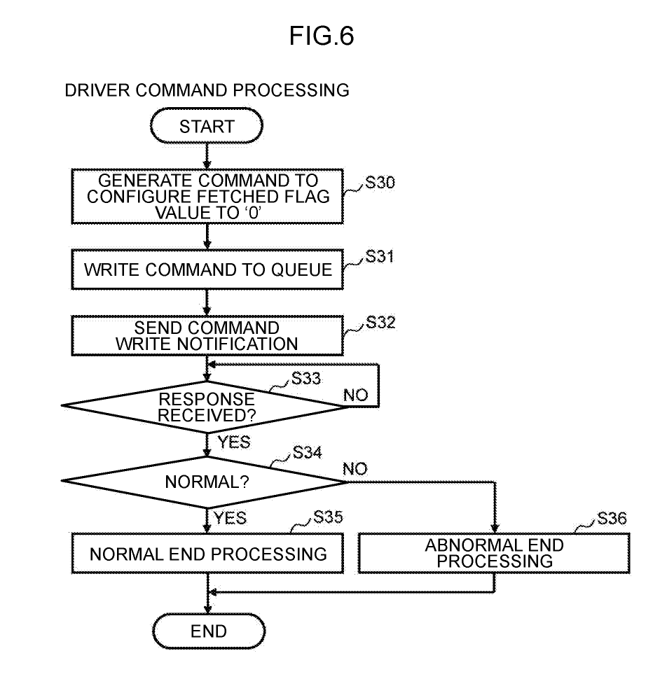

FIG. 6 shows the process steps of the driver command processing that is executed by the driver 13 of the storage controller 3 and relating to this fetched determination function.

Upon receiving the I/O request from the host device, the driver 13 starts the driver command processing shown in FIG. 6, and foremost generates a command in a predetermined format in response to the I/O request received (S30). Thereupon, the driver 13 configures the value of the fetched flag stored in the fetched flag field 30 (FIG. 4) to ‘0.’

Thereafter, the driver 13 writes the command generated in step S30 to the submission queue 14 which is associated with the corresponding SSD 2 (S31), and then sends a command write notification including the tail pointer to the SSD 2 (S32).

Subsequently, the driver 13 waits for a command execution result response to the command write notification to be sent back from the SSD 2 (S33), and when this command is then received, determines whether the content of the command execution result response thus received indicates normal completion (S34).

Upon obtaining an affirmative result in this determination, the driver 13 sends back the corresponding data read from the SSD 2 at the time (read data) if the now received I/O request from the host device is a read request, and if the I/O request is a write request, ends the driver command processing after sending notification that the corresponding data write was completed normally to the host device (S35).

On the other hand, when a negative result is obtained in the determination of step S34, the driver 13 notifies the host device that sent the now received I/O request of an error and executes predetermined abnormal end processing such as initialization of the SSD 2 or command re-execution (S36) and then ends the driver command processing.

### (1-3-2) Flash Controller Command Processing.

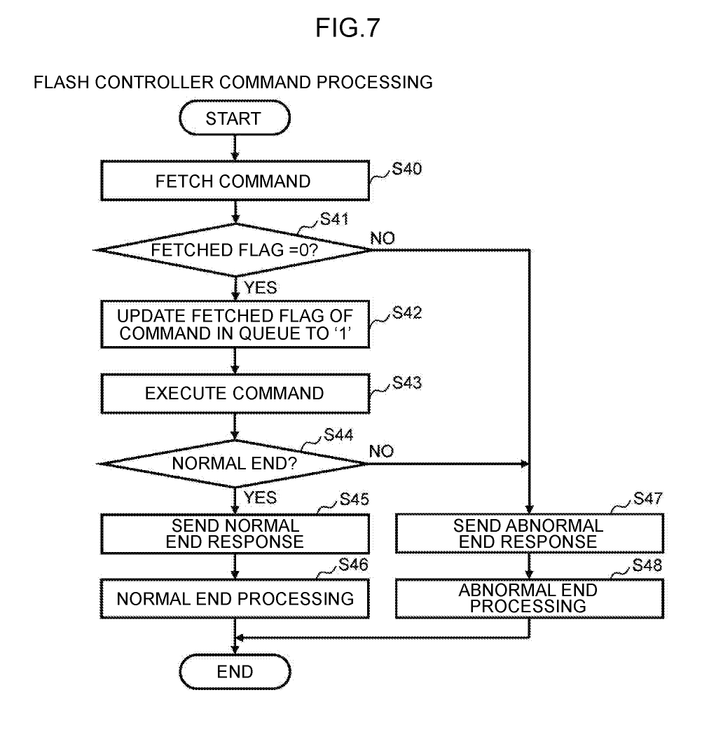

Meanwhile, FIG. 7 shows the process steps of the flash controller command processing that is executed by the flash controller 21 of the SSD 2 and relating to this fetched determination function.

In the flash controller 21, when the command write notification, issued by the driver in step S32 of the driver command processing described earlier with reference to FIG. 6, is received, the flash controller command processing shown in FIG. 7 is started.

Moreover, the command fetch control unit 24 (FIG. 1) of the flash controller 21 foremost accesses a submission queue 14 that has been allocated to the command fetch control unit 24, in the memory 11 (FIG. 1) of the storage controller 3 via the PCIe bus 15 (FIG. 1), and checks all the commands, among the commands stored in the submission queue 14, from the head pointer managed by the command fetch control unit 24 to the tail pointer notified by means of this command write notification (S40).

Thereafter, the fetched flag determination unit 28 (FIG. 1) of the command fetch control unit 24 determines whether, for each command fetched by the command fetch control unit 24 in step S40, the value of the fetched flag of these commands is ‘0’ (S41).

Further, when a negative result is obtained in this determination, the fetched flag determination unit 28 advances to step S47 and calls the command execution result response unit 26 (FIG. 1).

On the other hand, when an affirmative result is obtained in the determination in step S41, the fetched flag determination unit 28 calls the fetched flag write control unit 29 (FIG. 1). Further, when called by the fetched flag determination unit 28, the fetched flag write control unit 29 accesses the submission queue 14 which has been allocated to the fetched flag write control unit 29, in the memory 11 of the storage controller 3 via the PCIe bus 15, and updates the fetched flag of all the commands fetched in step S40, among the commands stored in the submission queue 14, to ‘1’ (S42).

Thereafter, the command execution unit 25 (FIG. 1) is called by the fetched flag write control unit 29, and each command fetched by the command fetch control unit 24 in step S40 is sequentially executed by the command execution unit 25 (S43).

Furthermore, when the execution of each command by the command execution unit 25 is complete, the command execution result response unit 26 (FIG. 1) is called by the command execution unit 25. Thereupon, the command execution unit 25 notifies the command execution result response unit 26 whether each command ended normally.

Moreover, when called by the command execution unit 25, the command execution result response unit 26 determines whether the command execution unit 25 was able to execute all the commands fetched in step S40 normally based on the execution result for each command which was notified by the command execution unit 25 at the time (S44)

When an affirmative result is obtained in this determination, the command execution result response unit 26 notifies the storage controller 3 of the command execution result response to that effect (S45). Moreover, if a read command is contained in the command fetched in step S40, the command execution result response unit 26 executes predetermined normal end processing such as storing data, which is read according to the command, in the memory 11 of the storage controller 3 (s46). As a result of the foregoing, the flash controller command processing ends.

If, on the other hand, a negative result is obtained in the determination of step S44, the command execution result response unit 26 advances to step S47 and notifies the storage controller 3 of the command execution result response to that effect (S47).

Moreover, the command execution result response unit 36 subsequently executes predetermined abnormal end processing such as discarding all of the commands fetched in step S40 in response to the reset instruction supplied from the driver 13 of the storage controller 3 (S48). As a result of the foregoing, the flash controller command processing ends.

(1-4) Effect of this Embodiment

As a result of the foregoing, in the storage apparatus 1 according to this embodiment, the driver 13 appends, to the command issued to the SSD 2, a fetched flag indicating whether the command has been fetched, and the driver 13 initializes the fetched flag (configures the flag to ‘0’) when writing the command to the submission queue 14, and updates the fetched flag value of the command in the submission queue 14 to ‘1’ each time the SSD 2 fetches the command from the corresponding submission queue 14.

Therefore, in the storage apparatus 1, because management, of which commands have or have not been fetched by the SSD 2 from the submission queue 14, can be performed collectively in the storage controller 3 for each SSD 2, even if the SSD 2 has been replaced, for example, the new post-replacement SSD 2 is able to recognize easily which command among the commands stored in the corresponding submission queue 14 to start processing.

Thus, according to the present invention, it is possible to realize a highly reliable storage apparatus 1 which is capable, even if the SSD 2 is replaced, of effectively and proactively preventing duplicate execution of commands by the new post-replacement SSD 2, and therefore of effectively preventing data loss caused by the duplicate execution of commands.

### (2) Second Embodiment

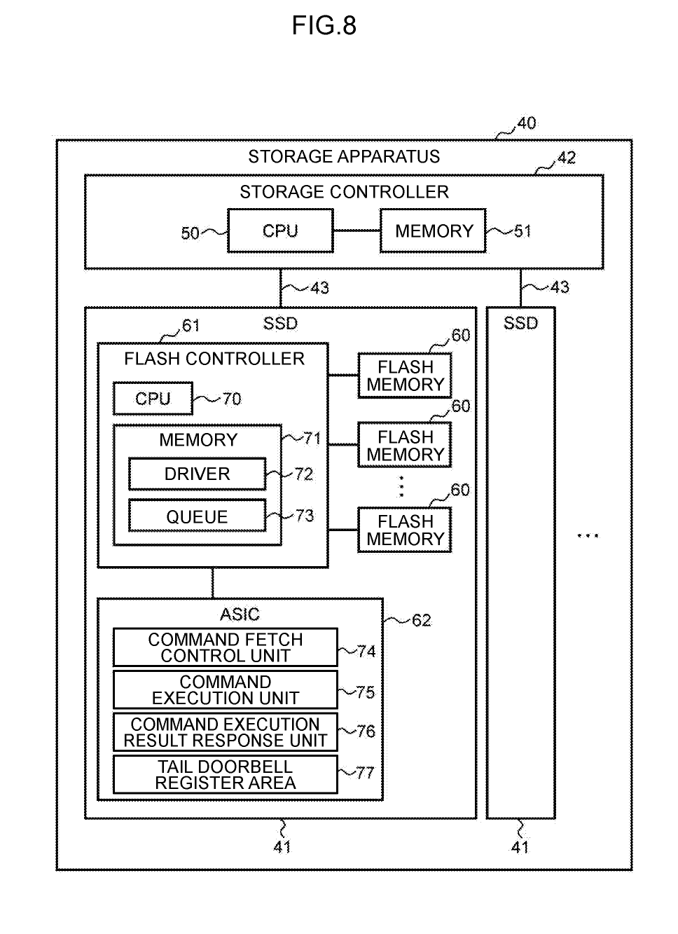

FIG. 8 shows a storage apparatus 40 according to a second embodiment. This storage apparatus 40 is configured by comprising one or more SSD 41 and a storage controller 42 which controls the reading and writing of data from/to the SSD 41.

The storage controller 42 is configured by comprising a CPU 50, and a memory 51.

The CPU 50 is a processor which is tasked with controlling the overall operation of the storage apparatus 40, and the memory 51 is a semiconductor memory that is used to hold various programs. The storage controller 42 is connected to each SSD 41 via a bus 43 based on the SAS (Serial Attached SCSI (Small Computer System Interface)) standard, for example.

The SSD 41 are each configured by comprising one or more flash memories 60 having a plurality of built-in NAND-type flash chips, a flash controller 61 which reads and write data from/to the corresponding flash memory 60 according to commands supplied from the storage controller 42, and one or more ASIC (Application Specific Integrated Circuit) 62 which carry out some of the processing of the flash controller 61, for example.

In the case of this embodiment, the ASIC 62 which is stored in the SSD 41 has a function for carrying out data treatment processing such as processing to compress write data and deduplication processing to remove duplicate data parts in the write data, for example.

The flash controller 61 comprises a CPU 70 which is a processor tasked with controlling the overall operation of the SSD 41, and a memory 71 that is mainly used to hold programs. A driver 72 for controlling the ASIC 62 is stored in the memory 71. Moreover, one or more submission queues 73 which have the same configuration as the submission queue 14 according to the first embodiment are defined on the memory 71 so as to correspond to each ASIC 62 provided in the SSD 41.

Moreover, the ASIC 62 each comprise a command fetch control unit 74, a command execution result response unit 76, and a tail doorbell register area 77 which have the same function and application as the command fetch control unit 24, command execution result response unit 26, and tail doorbell register area 27 of the first embodiment, respectively. Moreover, the ASIC 62 comprises a command execution unit 75 which is capable of executing the required data treatment processing according to internal commands, as described hereinabove. Note that the command fetch control unit 74, command execution unit 75, and command execution result response unit 76 may have either a hardware configuration or a software configuration.

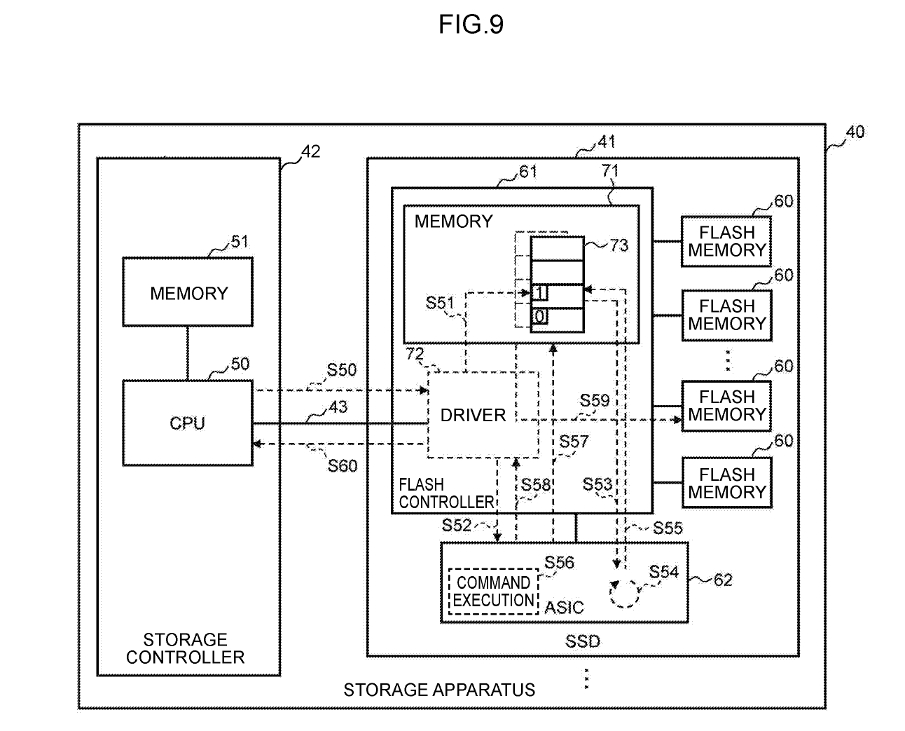

FIG. 9 shows the flow of serial write processing that is executed in the storage apparatus 40 according to this embodiment when a write request is supplied from the host device.

In this case, the storage controller 42 of the storage apparatus 40, which has received the write command, generates a write command according to the received write request. Further, the storage controller 42 sends the generated write command to the corresponding SSD 41 via the bus 43 (S50).

Further, the storage controller 42 sends this write command, and write target data (write data), which has been sent together with the write request from the host device, to the SSD 41 via the bus 43. Thus, the write data is stored in the memory 71 of the flash controller 61 of the SSD 41 (S50).

Meanwhile, the driver 72 of the flash controller 61 of the SSD 41, which has received the write command, generates an internal command to execute processing to treat the write data in the SSD 41 based on the received write command (hereinafter called the internal command), and writes this command to the corresponding submission queue 73 defined in the memory 71 (S51). Note that the command format of the internal command generated at this time is the same as the command format described earlier with reference to FIG. 4. Moreover, the value of the fetched flag which is stored in the fetched flag field 30 (FIG. 4) in the internal command is configured to ‘0.’

Moreover, the driver 72 then sends a command write notification that the internal command has been written to the corresponding submission queue 73 in the memory 71 to the corresponding ASIC 62 (S52). Note that the command write notification includes a tail pointer which indicates the position of the internal command (a position starting from the head of the submission queue 73) which was written last to the corresponding submission queue 73 at the time. Further, this tail pointer is stored in the tail doorbell register area 77 of the ASIC 62 (FIG. 8).

Meanwhile, the command fetch control unit 74 (FIG. 8) of the ASIC 62 stores the position of the oldest non-executed internal command among the internal commands written to the corresponding submission queue 73 as the head pointer (see FIG. 3).

Moreover, if this command write notification is supplied, the command fetch control unit 74 accesses the corresponding submission queue 73 which is defined in the memory 71 of the flash controller 61, and fetches all the internal commands, from the head pointer to the tail pointer stored in the tail doorbell register area 77, among the internal commands stored in the submission queue 73 (S53).

Further, the command fetch control unit 74 subsequently confirms each of the values of the fetched flags of the internal commands fetched at the time and determines whether all the values of the fetched flags of the internal commands are ‘0’ (S54).

If the values of the fetched flags of these internal commands are all ‘0,’ the command fetch control unit 74 accesses the corresponding submission queue 73 in the memory 71 of the flash controller 61, and updates each of the fetched flags of the internal commands fetched at the time to ‘1’ (S55).

Thereafter, the command fetch control unit 74 transfers the internal commands fetched in step S53 to the command execution unit 75 in order (in the order in which the internal commands were written to the corresponding submission queue 73) (FIG. 8). Furthermore, the command execution unit 75 sequentially executes processing on the write data which is stored in the memory 71 of the flash controller 61, based on the internal commands transferred from the command fetch control unit 74 at the time (S56).

Furthermore, the command execution unit 75 writes back the treated write data which was obtained by subjecting the write data to the data treatment processing according to these internal commands to the memory 71 of the flash controller 61 (S57).

Moreover, the command execution unit 75 calls the command execution result response unit 76 (FIG. 8) when the execution of all the internal commands fetched in step S53 is complete. Thereupon, the command execution unit 75 notifies the command execution result response unit 76 of the execution result of each internal command. Moreover, when called by the command execution unit 75, the command execution result response unit 76 notifies the driver 72 of the flash controller 61 of the execution result of each internal command notified by the command execution unit 75 (S58).

Furthermore, the driver 72 of the flash controller 61, which has received the notification, reads the treated write data, which is write data that has undergone data treatment processing, in the ASIC 62 according to each internal command fetched in step S53, from the memory 71, and stores the treated write data thus read in the corresponding flash memory 60 (S59).

Note that the driver 72 subsequently sends a write completion notification that the writing of this write data is complete, to the storage controller 42 via the bus 43 (S60). Furthermore, the storage controller 42, which has received this write completion notification, sends a write processing completion notification corresponding to the write completion notification to the host device which sent the write request. As a result of the foregoing, the write processing of the storage apparatus 40 which corresponds to the write request from the host device is completed.

As a result of the foregoing, so too in the storage apparatus 40 according to this embodiment, the driver 72 appends, to the command issued to the ASIC 62, a fetched flag indicating whether the command has been fetched, and the driver 72 initializes the fetched flag (configures the flag to ‘0’) when writing the command to the submission queue 73, and updates the fetched flag value of the command in the submission queue 73 to ‘1’ each time the ASIC 62 fetches the command from the corresponding submission queue 73.

Thus, according to the storage apparatus 40 of this embodiment, like the storage apparatus 1 of the first embodiment, it is possible to realize a highly reliable storage apparatus 40 which is capable, even if the ASIC 62 is replaced, of effectively and proactively preventing duplicate execution of commands by the new post-replacement ASIC 62, and therefore of effectively preventing data loss caused by the duplicate execution of commands.

### (3) Other Embodiments

Note that, although a case where the present invention was applied to the storage apparatus 1, 40 was described in the foregoing first and second embodiments, the present invention is not limited to or by the foregoing and can be applied widely to a variety of information processing systems such as a server apparatus or other computer apparatus which comprises one or more devices which execute predetermined processing, a controller which controls the devices, and a memory which is provided in the controller and in which command queues for each device are defined.

Moreover, although a case where one or more devices which execute predetermined processing are the SSD 2, 41 was described in the first and second embodiments, the present invention is not limited to or by the foregoing and can be applied widely to storage devices other than the SSD 2, 41, such as a hard disk device.

Moreover, although a case where the fetched flag field 30 (FIG. 4) is provided at the head of a command was described in the first and second embodiments, the present invention is not limited to or by the foregoing, rather, the position of the fetched flag field 30 may be configured in a location other than the head of a command.

Moreover, although a case where a flag is applied as fetch information (a fetched flag) indicating whether a command has been fetched was described in the first and second embodiments, the present invention is not limited to or by the foregoing, and information in a variety of other forms can be widely applied. However, by applying a flag as this fetch information, it is possible to represent whether a command has been fetched using a single bit, and therefore an increased volume for the submission queue 14, 73 storing the commands, and the like, can be efficiently prevented.

The present invention can be applied widely to a variety of information processing systems which comprise one or more devices which execute predetermined processing, a controller which controls the devices, and a memory which is provided in the controller and in which command queues for each device are defined.

What is claimed is:

1. An information processing system, comprising:
one or more devices which execute predetermined processing;
a controller which controls the devices; and
a memory which is provided in the controller and in which command queues for each of the devices are defined,
wherein the controller writes a command for a device among the devices to a corresponding command queue which is the command queue corresponding to the device,
wherein the device fetches the command from the corresponding command queue,
wherein the command includes a field for storing fetch information which indicates whether the command has been fetched,
wherein the device refers to a value of the fetch information of the fetched command, and
wherein, if the value of the fetch information is a first value indicating that the command has not been fetched, the device executes the command after updating the value of the fetch information of the command which is stored in the corresponding command queue to a second value indicating that the command has been fetched, and if the value of the fetch information is the second value, the device executes predetermined error processing instead of executing the command.

2. The information processing system according to claim 1,
wherein the fetch information is a flag.

3. The information processing system according to claim 1,
wherein the error processing is an error notification for the controller,
wherein, if an error is notified by the device, the controller issues an instruction to the device to discard all of the held commands, initializes the corresponding command queue, rewrites, to the command queue, the non-executed commands which were written to the corresponding command queue before initialization, and issues, to the device, a command write notification where the non-executed commands have been written to the corresponding command queue, and
wherein the device fetches commands from the corresponding command queue in response to the command write notification.

4. The information processing system according to claim 1,
wherein the devices are storage devices which are installed in a storage apparatus, and
wherein the controller is a storage controller which is installed in the storage apparatus and which controls the devices.

5. An information processing method which is executed in an information processing system which comprises one or more devices which execute predetermined processing, a controller which controls the devices, and a memory which is provided in the controller and in which command queues for each of the devices are defined, the information processing method comprising:
a first step in which a device among the devices refers to a value of fetch information of a command fetched by the device, wherein the controller writes the command for the device to a corresponding command queue which is the command queue corresponding to the device, the command includes a field for storing the fetch information which indicates whether the command has been fetched, and the device fetches the command from the corresponding command queue; and
a second step in which the device executes, if the value of the fetch information is a first value indicating that the command has not been fetched, the command after updating the value of the fetch information of the command which is stored in the command queue to a second value indicating that the command has been fetched, and the device executes, if the value of the fetch information is the second value, predetermined error processing instead of executing the command.

6. The information processing method according to claim 5,
wherein the fetch information is a flag.

7. The information processing method according to claim 5, further comprising:
a third step in which the controller issues, if an error is notified by the device, an instruction to the device to discard all of the held commands, initializing the corresponding command queue, rewrites, to the command queue, the non-executed commands which were written to the command queue before initialization, and issues, to the device, a command write notification where the non-executed commands have been written to the corresponding command queue, wherein the error processing is an error notification for the controller; and
a forth step in which the device fetches commands from the corresponding command queue in response to the command write notification.

8. The information processing method according to claim 5,
wherein the devices are storage devices which are installed in a storage apparatus, and
wherein the controller is a storage controller which is installed in the storage apparatus and which controls the devices.
